(19) United States
(12) Patent Application Publication
(10) Pub. No.: US 2026/0340763 A1
(43) Pub. Date: Oct. 29, 2026

(54) FOVEATED SCALING FOR RENDERING AND BANDWIDTH WORKLOADS

(71) Applicant: QUALCOMM Incorporated, San Diego, CA (US)

(72) Inventors: Jonathan WICKS, Lafayette, CO (US); Mark STERNBERG, Toronto (CA); Daniel STAN, Thornhill (CA); Samuel Benjamin HOLMES, Sterling, MA (US)

(21) Appl. No.: 19/099,042

(22) PCT Filed: Jun. 21, 2023
(86) PCT No.: PCT/US2023/025834

§ 371 Date: Jan. 27, 2025

Related U.S. Application Data
(63) Continuation of application No. 17/816,976, filed on Aug. 2, 2022, now abandoned.

(51) Int. Cl. G06T 3/40; G06T 5/70; G06T 5/80; G06T 9/00

(52) U.S. Cl. CPC G06T 3/40; G06T 5/70; G06T 5/80; G06T 9/00

(57) ABSTRACT

Aspects presented herein relate to methods and devices for graphics processing including an apparatus, e.g., a GPU or a DPU. The apparatus may obtain at least one image in a set of images corresponding to a scene associated with the graphics processing. The apparatus may also perform a non-linear foveated compression process on the at least one image, where the non-linear foveated compression process corresponds to a continuous non-linear compression for a portion of the at least one image. The apparatus may also transmit the at least one image after the non-linear foveated compression process, such that the transmitted at least one image corresponds to at least one compressed image.

### CROSS-REFERENCE TO RELATED APPLICATION

This application claims the benefit of U.S. patent application Ser. No. 17/816,976, entitled “FOVEATED SCALING FOR RENDERING AND BANDWIDTH WORKLOADS” and filed on Aug. 2, 2022, which is expressly incorporated by reference herein in its entirety.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), a display processing unit (DPU) or any apparatus that may perform graphics processing. The apparatus may obtain at least one image in a set of images corresponding to a scene associated with the graphics processing. The apparatus may also perform a non-linear foveated compression process on the at least one image, where the non-linear foveated compression process corresponds to a continuous non-linear compression for a portion of the at least one image. Further, the apparatus may encode the at least one image after the non-linear foveated compression process is performed and before the at least one image is transmitted. The apparatus may also transmit the at least one image after the non-linear foveated compression process, such that the transmitted at least one image corresponds to at least one compressed image.

In an aspect of the disclosure, a method, a computer-readable medium, and an apparatus are provided. The apparatus may be a display processing unit (DPU), a graphics processing unit (GPU), a central processing unit (CPU), or any apparatus that may perform graphics processing. The apparatus may obtain at least one compressed image in a scene associated with the graphics processing, where the at least one compressed image is associated with a non-linear foveated compression process. The apparatus may also decode the at least one compressed image after the at least one compressed image is obtained and before a non-linear foveated decompression process is performed. Further, the apparatus may perform a non-linear foveated decompression process on the at least one compressed image, such that the at least one compressed image corresponds to at least one image, where the non-linear foveated decompression process corresponds to a continuous non-linear decompression for a portion of the at least one image. Additionally, the apparatus may transmit the at least one image after the non-linear foveated decompression process.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram 400 illustrating an example field of view (FoV) for graphics processing.

FIG. 5 is a graph illustrating an example of input-to-output mapping for graphics processing.

FIG. 6 is a diagram illustrating an example foveated scaling process for graphics processing.

FIG. 7 is a diagram illustrating an example pipeline flow including foveated scaling for graphics processing.

FIG. 8 is a diagram illustrating an example vertex mesh for graphics processing.

FIG. 9 is a diagram illustrating an example non-linear scaling process for graphics processing.

FIG. 10 is a diagram illustrating an example non-linear scaling process for graphics processing.

FIG. 11 is a communication flow diagram illustrating example communications between a GPU, a GPU component, a DPU, and a display panel.

FIG. 12 is a flowchart of an example method of graphics processing.

FIG. 13 is a flowchart of an example method of graphics processing.

FIG. 14 is a flowchart of an example method of graphics processing.

FIG. 15 is a flowchart of an example method of graphics processing.

### DETAILED DESCRIPTION

Some aspects of graphics processing may be associated with different types of applications (e.g., extended reality (XR), augmented reality (AR), or virtual reality (VR) applications). XR, AR, or VR systems utilized with certain devices (e.g., mobile devices or smartphones) may be under certain constraints for power and performance efficiency, as well as certain benchmarks for realistic or photo-realistic content. In order to achieve photo-realistic XR, AR, and VR systems, display and render resolutions may continue to increase. Traditionally, time warp (i.e., timewarp) or composition procedures may output to a full display resolution, with a lens distortion curve, and pass this through a display processing unit (DPU) and then to a display panel. As resolutions increase, this brute force approach may utilize a substantial amount of system memory bandwidth, which may outpace any year-over-year improvements. There is also demand on GPU rendering, as it utilizes high DPU clock rates to send the data to the display panel. XR, AR, and VR systems may also use lenses to magnify the display and provide a high field of view (FoV). The lenses used to magnify the display may typically have a highest clarity in the optical center and have a falloff in quality towards the edges. Furthermore, lenses may have pincushion distortion, which the compositor may counter with barrel distorted rendering (i.e., barrel distortion). As a result, the pixels in the periphery may be under sampled compared to pixels in the fovea when barrel distorted, but then the pixels may be expanded when passing through the lens. This process may reduce the visual quality around the edges of the image. One method to try to reduce this pressure and reduced visual quality is to scale the time warp output and use the DPU to upscale to the panel resolution. This may reduce the system memory bandwidth, but it may not relieve pressure on the data rate to the panel. This also may imply that the fovea area (i.e., the area corresponding to the center of the lens) loses some clarity, as well as the peripheral area (i.e., the area corresponding to the edges of the lens). Alternative solutions may use multiple layers, typically with a fovea layer that is not upscaled and one or more peripheral layers that are DPU scaled. While this may address the fovea scaling issue, it may also specify that multiple layers are passed to the DPU. Additionally, this solution may specify overlapping regions and alpha blending in order to avoid hard edges at the boundary transitions. Aspects of the present disclosure may utilize compression scaling that matches human perception and/or the optics of the lenses used in certain systems (e.g., XR, AR, and VR systems). For instance, aspects of the present disclosure may employ non-linear foveated compression scaling in XR, AR, and VR systems. More specifically, aspects of the present disclosure may employ non-linear foveated compression scaling as the output of certain procedures (e.g., time warp procedures). Also, utilizing the non-linear foveated compression scaling as an output of time warp procedures may match human perception and/or the optics of the lenses used in XR, AR, and VR systems. The non-linear encoding may also reduce the footprint of the output buffer (e.g., the time warp output buffer). The non-linear foveated compression scaling may reduce the pixel count of certain time warp procedures by a certain amount (e.g., reduce the pixel count by around 56%). In some aspects, the non-linear foveated compression scaling may be decoded at the DPU or at a panel display driver integrated circuit (DDIC). Further, the non-linear foveated compression scaling may reduce both rendering workload and bandwidth pressure.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

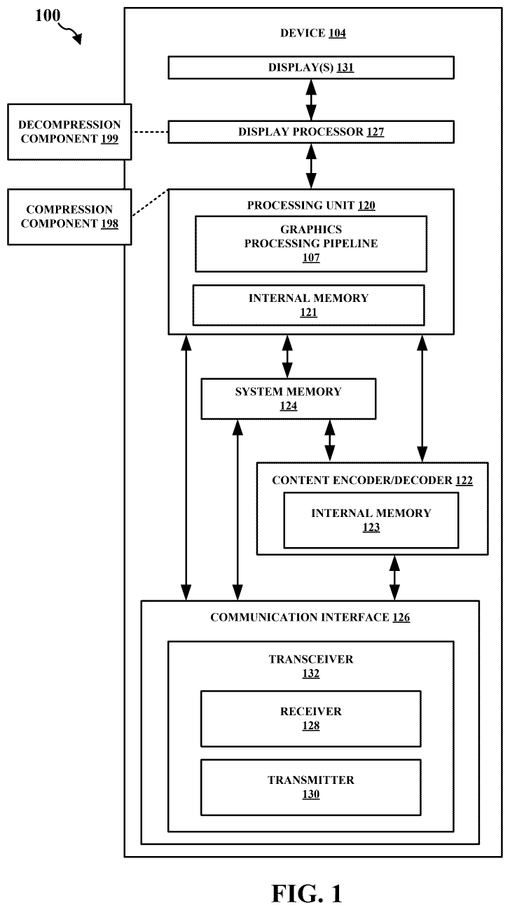

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a compression component 198 that is configured to obtain at least one image in a set of images corresponding to a scene associated with the graphics processing. The compression component 198 may also be configured to perform a non-linear foveated compression process on the at least one image, where the non-linear foveated compression process corresponds to a continuous non-linear compression for a portion of the at least one image. The compression component 198 may also be configured to encode the at least one image after the non-linear foveated compression process is performed and before the at least one image is transmitted. The compression component 198 may also be configured to transmit the at least one image after the non-linear foveated compression process, such that the transmitted at least one image corresponds to at least one compressed image.

Referring again to FIG. 1, in certain aspects, the display processor 127 may include a decompression component 199 that is configured to obtain at least one compressed image in a scene associated with the graphics processing, where the at least one compressed image is associated with a non-linear foveated compression process. The decompression component 199 may also be configured to decode the at least one compressed image after the at least one compressed image is obtained and before a non-linear foveated decompression process is performed. The decompression component 199 may also be configured to perform a non-linear foveated decompression process on the at least one compressed image, such that the at least one compressed image corresponds to at least one image, where the non-linear foveated decompression process corresponds to a continuous non-linear decompression for a portion of the at least one image. The decompression component 199 may also be configured to transmit the at least one image after the non-linear foveated decompression process. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

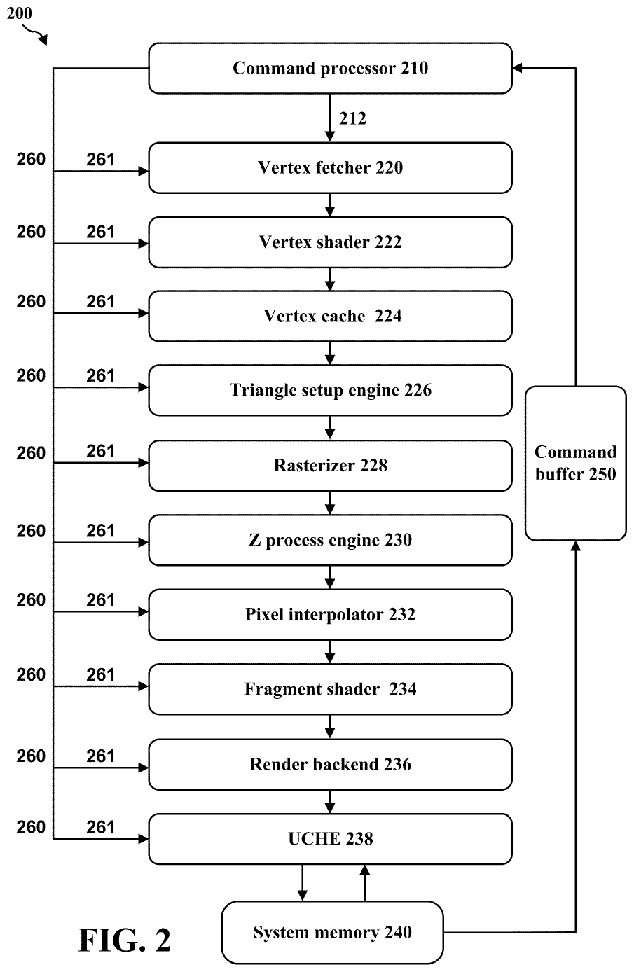

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

In some aspects, GPUs may apply the drawing or rendering process to different bins or tiles. For instance, a GPU may render to one bin, and perform all of the draws for the primitives or pixels in the bin. During the process of rendering to a bin, the render targets may be located in the GMEM. In some instances, after rendering to one bin, the content of the render targets may be moved to a system memory and the GMEM may be freed for rendering the next bin. Additionally, a GPU may render to another bin, and perform the draws for the primitives or pixels in that bin. Therefore, in some aspects, there might be a small number of bins, e.g., four bins, that cover all of the draws in one surface. Further, GPUs may cycle through all of the draws in one bin, but perform the draws for the draw calls that are visible, i.e., draw calls that include visible geometry. In some aspects, a visibility stream may be generated, e.g., in a binning pass, to determine the visibility information of each primitive in an image or scene. For instance, this visibility stream may identify whether a certain primitive is visible or not. In some aspects, this information may be used to remove primitives that are not visible, e.g., in the rendering pass. Also, at least some of the primitives that are identified as visible may be rendered in the rendering pass.

In some aspects of tiled rendering, there may be multiple processing phases or passes. For instance, the rendering may be performed in two passes, e.g., a visibility or bin-visibility pass and a rendering or bin-rendering pass. During a visibility pass, a GPU may input a rendering workload, record the positions of the primitives or triangles, and then determine which primitives or triangles fall into which bin or area. In some aspects of a visibility pass, GPUs may also identify or mark the visibility of each primitive or triangle in a visibility stream. During a rendering pass, a GPU may input the visibility stream and process one bin or area at a time. In some aspects, the visibility stream may be analyzed to determine which primitives, or vertices of primitives, are visible or not visible. As such, the primitives, or vertices of primitives, that are visible may be processed. By doing so, GPUs may reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information may be used to determine or generate a visibility stream. In a rendering pass, the primitives in each bin may be rendered separately. In these instances, the visibility stream may be fetched from memory used to drop primitives which are not visible for that bin.

Some aspects of GPUs or GPU architectures may provide a number of different options for rendering, e.g., software rendering and hardware rendering. In software rendering, a driver or CPU may replicate an entire frame geometry by processing each view one time. Additionally, some different states may be changed depending on the view. As such, in software rendering, the software may replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware may manage the replication or processing of the primitives or triangles for each viewpoint in an image.

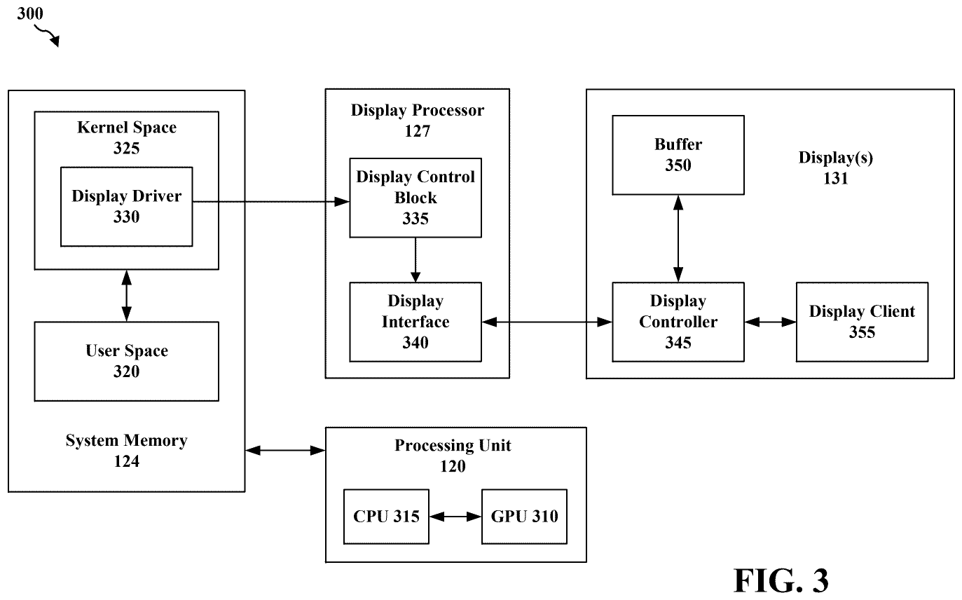

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

Some aspects of graphics processing may be associated with different types of applications (e.g., extended reality (XR), augmented reality (AR), or virtual reality (VR) applications). XR, AR, or VR systems utilized with certain devices (e.g., mobile devices or smartphones) may be under certain constraints for power and performance efficiency, as well as certain benchmarks for realistic or photo-realistic content. In order to achieve photo-realistic XR, AR, and VR systems, display and render resolutions may continue to increase. Traditionally, time warp (i.e., timewarp) or composition procedures may output to a full display resolution, with a lens distortion curve, and pass this through a display processing unit (DPU) and then to a display panel. As resolutions increase, this brute force approach may utilize a substantial amount of system memory bandwidth, which may outpace any year-over-year improvements. There is also demand on performance and power, for the GPU to render those pixels and the high DPU clock rates to send them to the display panel.

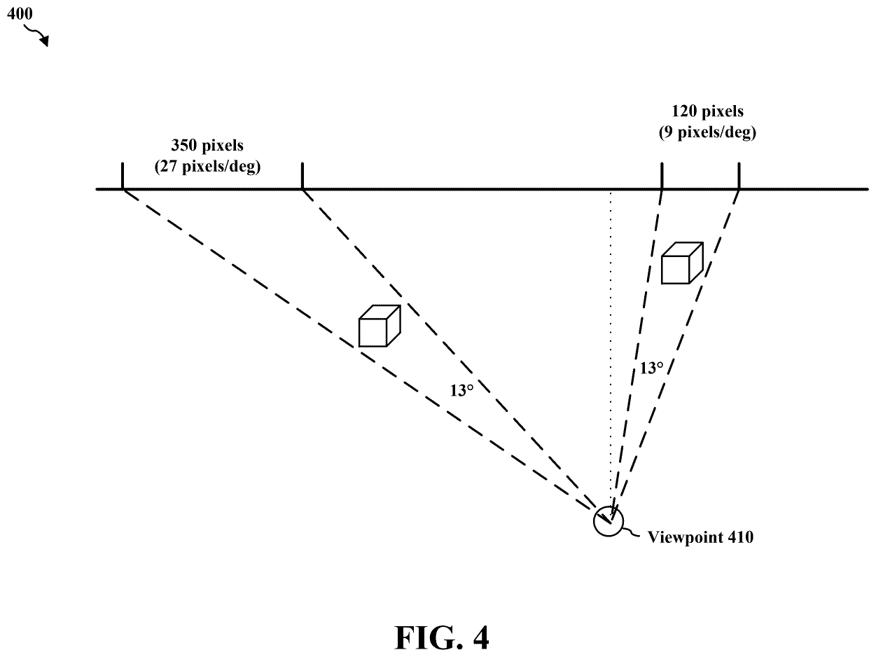

XR, AR, and VR systems may also use lenses to magnify the display and provide a high field of view (FoV), as shown in FIG. 4. FIG. 4 is a diagram 400 illustrating an example FoV for graphics processing. More specifically, diagram 400 depicts a FoV from viewpoint 410, which includes 350 pixels in one direction (e.g., 27 pixels per degree) and 120 pixels in another direction (e.g., 9 pixels per degree). The lenses used to magnify the display may typically have a highest clarity in the optical center and have a falloff in quality towards the edges. Furthermore, lenses may have pincushion distortion, which the compositor may counter with barrel distorted rendering (i.e., barrel distortion). As a result, the pixels in the periphery may be under sampled compared to pixels in the fovea when barrel distorted, but then the pixels may be expanded when passing through the lens. This process may reduce the visual quality around the edges of the image.

One method to try to reduce this pressure and reduced visual quality is to scale the time warp output and use the DPU to upscale to the panel resolution. This may reduce the system memory bandwidth, but it may not relieve pressure on the data rate to the panel. This also may imply that the fovea area (i.e., the area corresponding to the center of the lens) loses some clarity, as well as the peripheral area (i.e., the area corresponding to the edges of the lens). Alternative solutions may use multiple layers, typically with a fovea layer that is not upscaled and one or more peripheral layers that are DPU scaled. While this may address the fovea scaling issue, it may also specify that multiple layers are passed to the DPU. Additionally, this solution may specify overlapping regions and alpha blending in order to avoid hard edges at the boundary transitions. Based on the above, it may be beneficial to utilize compression scaling that matches human perception and/or the optics of the lenses used in XR, AR, and VR systems.

Aspects of the present disclosure may utilize compression scaling that matches human perception and/or the optics of the lenses used in certain systems (e.g., XR, AR, and VR systems). For instance, aspects of the present disclosure may employ non-linear foveated compression scaling in XR, AR, and VR systems. More specifically, aspects of the present disclosure may employ non-linear foveated compression scaling as the output of certain procedures (e.g., time warp procedures). Also, utilizing the non-linear foveated compression scaling as an output of time warp procedures may match human perception and/or the optics of the lenses used in XR, AR, and VR systems. The non-linear encoding may also reduce the footprint of the output buffer (e.g., the time warp output buffer). The non-linear foveated compression scaling may reduce the pixel count of certain time warp procedures by a certain amount (e.g., reduce the pixel count by around 56%). In some aspects, the non-linear foveated compression scaling may be decoded at the DPU or at a panel display driver integrated circuit (DDIC). Further, the non-linear foveated compression scaling may reduce both rendering workload and bandwidth pressure.

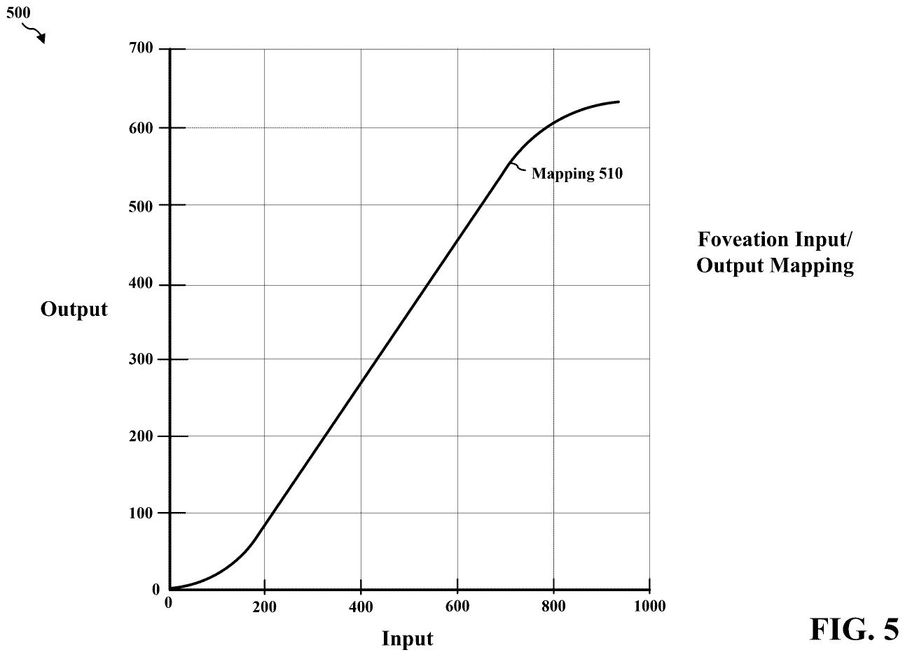

FIG. 5 is a graph 500 illustrating an example of input-to-output mapping. More specifically, the graph 500 depicts foveation input-to-output mapping for the mapping 510. As shown in FIG. 5, graph 500 includes certain foveation inputs (e.g., inputs of 0, 200, 400, 600, 800, and 1000) and certain foveation outputs (e.g., outputs of 0, 100, 200, 300, 400, 500, 600, and 700). As illustrated in FIG. 5, the fovea region of the image may include a certain scaling (e.g., a 1:1 scaling), while the periphery region of the image may include a parabolic distortion. Also, as shown in FIG. 5, there may be a smooth transition between the fovea region and the periphery region.

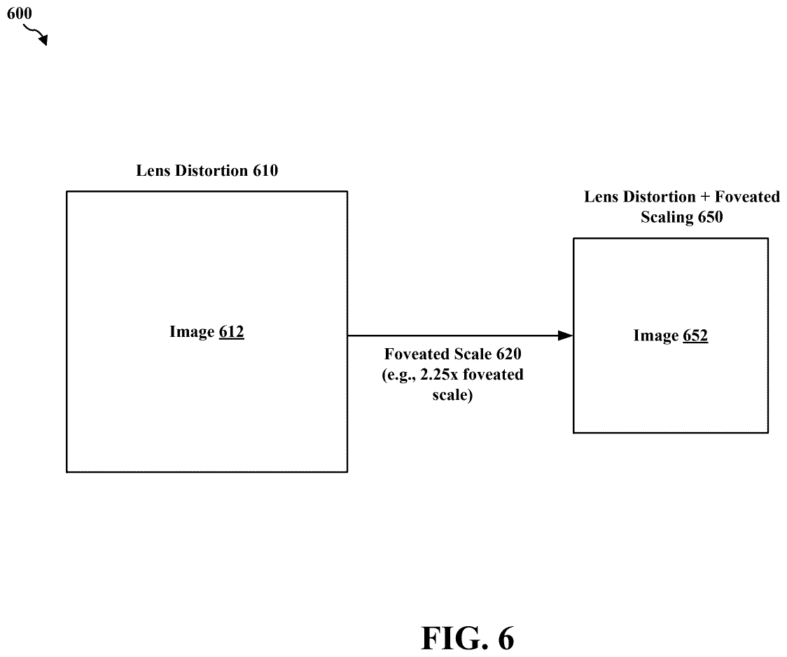

FIG. 6 is a diagram 600 illustrating an example foveated scaling process for graphics processing. More specifically, diagram 600 depicts a certain foveated scale (e.g., a 2.25× foveated scale) applied to an image with lens distortion. As shown in FIG. 6, diagram 600 includes lens distortion 610 and corresponding image 612, foveated scale 620 (e.g., a 2.25× foveated scale), as well as lens distortion and foveated scaling 650 including corresponding image 652. FIG. 6 depicts that a foveated scale 620 (e.g., a 2.25× foveated scale) is applied to image 612 in order to produce image 652. Further, FIG. 6 shows a 2.25× reduction in a time warp workload. This process may save bandwidth, save rendering time, and/or preserve the quality of the image. Image 612 may include a certain resolution (e.g., 1832×1920 pixels) and image 652 may include another resolution (e.g., 1221×1280 pixels). For example, a 1:1 scaling for a center 50% of the image may correspond to 916×960 pixels per eye. Also, this may correspond to a certain amount of pixels (e.g., 25% of the pixels) on each side of the image being compressed into a certain amount of the output buffer (e.g., 12.5% of the output buffer). In some aspects, there may be an overlay of the original and foveated scaling, which may produce a 1:1 preserved content in the center with smooth scaling to the edge of the image.

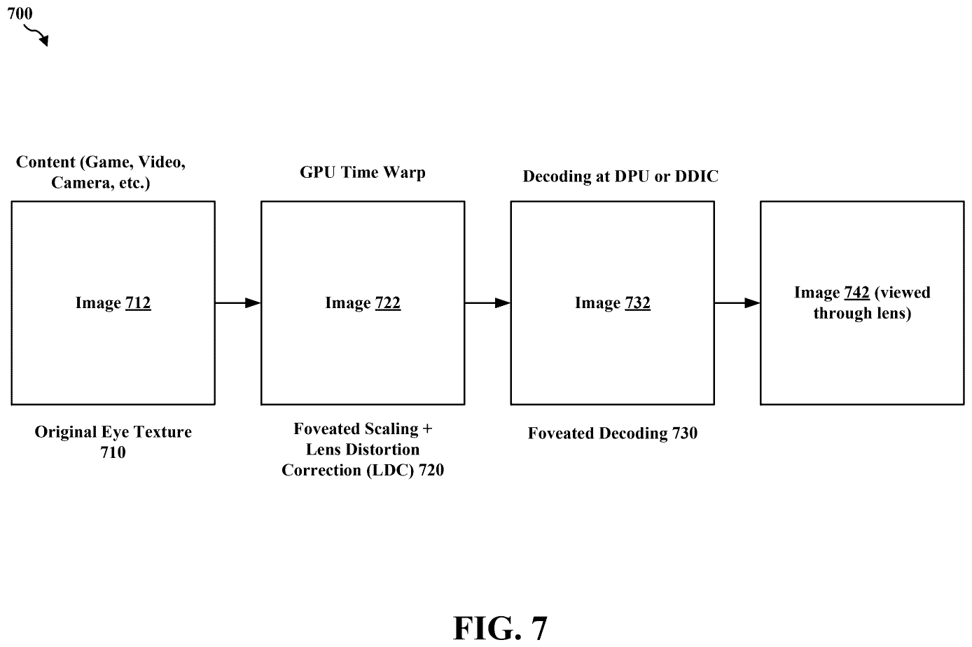

FIG. 7 is a diagram 700 illustrating an example pipeline flow including foveated scaling for graphics processing. More specifically, diagram 700 depicts a pipeline flow including a certain foveated scale applied to an image with lens distortion, foveated scaling, and foveated decoding. As shown in FIG. 7, diagram 700 includes original eye texture 710 and corresponding image 712, foveated scaling and lens distortion correction (LDC) (e.g., foveated scaling and LDC 720) including corresponding image 722, a foveated decoding process 730 and corresponding image 732, and well as the image viewed through the lens (e.g., image 742). FIG. 7 depicts that image 712 is associated with certain content (e.g., game, video, or camera content), image 722 is associated with a GPU time warp process, and image 732 is associated with decoding at a DPU or a DDIC. Additionally, the LDC and foveated scaling (e.g., foveated scaling and LDC 720) may be performed in a single pass. This may be a simple modification to an existing time warp process.

The non-linear foveated compression process described herein may include a number of benefits and advantages. For instance, the non-linear foveated compression process may add to existing GPU composition as part of a lens distortion mapping (e.g., a chrominance (UV) or vertex lens distortion mapping). The non-linear foveated compression process may also substantially reduce the rendering workload and system bandwidth, such as by providing a footprint compressed output buffer that retains a full resolution in the fovea region of an image and use just the memory necessary to represent the under-sampled periphery of the image. Further, certain data rates (e.g., system on-chip (SoC)-to-panel data rates) may be reduced if the decoding is performed at the display panel instead of at the DPU. Also, there may be a smooth transition from the fovea to the periphery of the image without a need to over-render or over-blend. The non-linear foveated compression/decompression may also utilize a single layer at the DPU. This single layer solution for non-linear foveated compression/decompression may also avoid the complexity of handling multiple layers at the DPU.

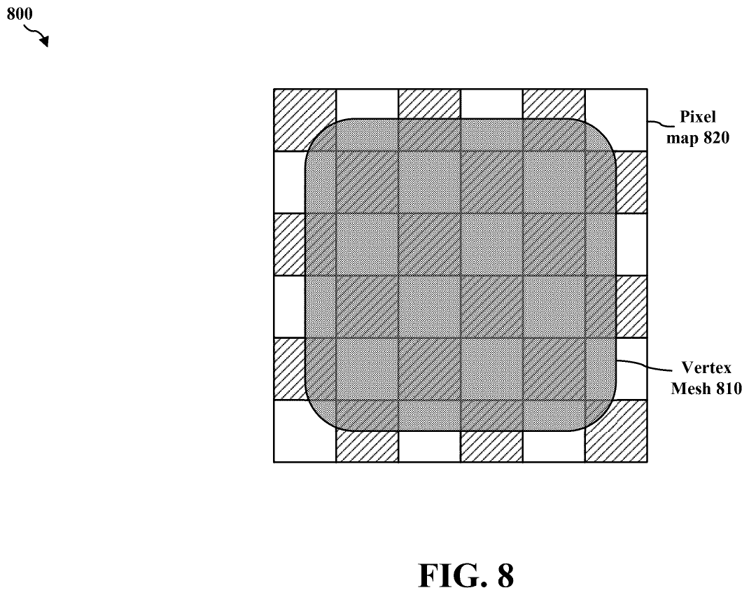

In some aspects, a GPU may render to a certain type of reduced memory buffer (e.g., a smaller backbuffer that is footprint compressed). For example, for certain resolutions (e.g., 2400×2400 pixels to 1600×1600 pixels) of an image, a GPU may utilize a reduced system memory buffer (e.g., a 56% smaller system memory buffer). Also, when utilizing the reduced system memory buffer, a vertex mesh may remain a similar shape (e.g., a flat or square vertex mesh similar to the vertex mesh in FIG. 8). FIG. 8 is a diagram 800 illustrating an example vertex mesh for graphics processing. More specifically, diagram 800 depicts vertex mesh 810 on top of pixel map 820. As depicted in FIG. 8, vertex mesh 810 may be flat or square in shape.

Additionally, in some aspects, a UV-to-vertex mapping of an image may correspond to lens distortion for an image. In other aspects, a UV-to-vertex mapping of an image may equal lens distortion and foveation encoding (e.g., that is performed in a vertex shader). Further, the DPU may reverse the foveation encoding, and may leverage existing chromatic aberration correction hardware to perform non-linear scaling. This may reduce system bandwidth (e.g., GPU-to-DPU system bandwidth), but still expand on SoC output. In order to do so, there may be multiple options: (1) process two layers at a DPU (e.g., one layer for the fovea of an image and another layer for the periphery of an image), or (2) process one layer at a DPU (e.g., one layer for both the fovea and the periphery of an image). Aspects presented herein may also implement non-linear scaling (e.g., implemented at a panel DDIC) to further reduce the bandwidth from the SoC to the panel.

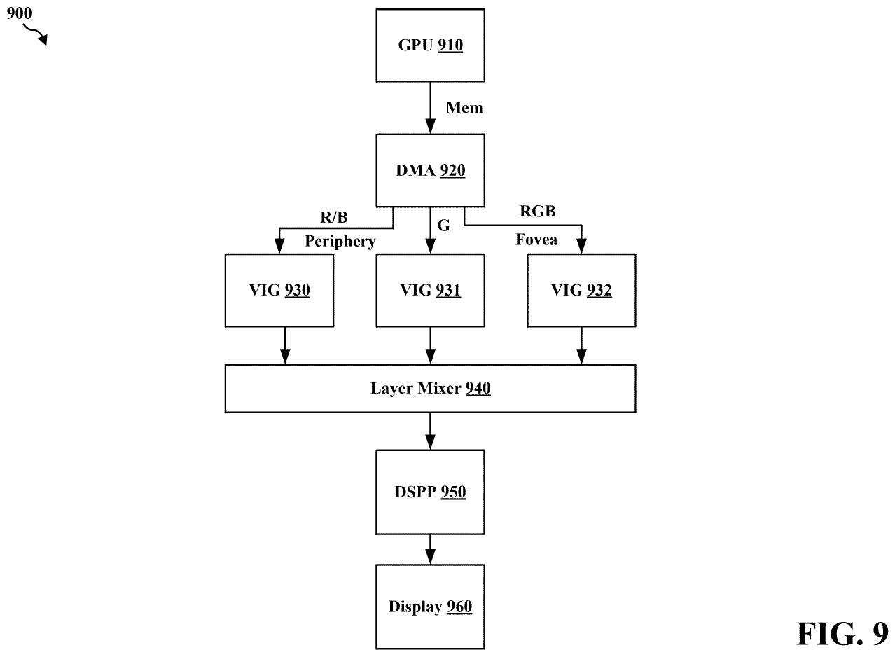

FIG. 9 is a diagram 900 illustrating an example non-linear scaling process for graphics processing. More specifically, diagram 900 depicts a non-linear scaling process that processes multiple layers at a DPU. As shown in FIG. 9, diagram 900 includes GPU 910, direct memory access (DMA) processor (e.g., DMA 920), video graphics (VIG) processor (e.g., VIG 930, VIG 931, and VIG 932), layer mixer 940, destination surface processor (DSPP) (e.g., DSPP 950) and display 960. FIG. 9 depicts that memory data is sent from GPU 910 to DMA 920. After this, the red (R) and blue (B) (R/B) channels and the periphery data are sent from DMA 920 to VIG 930. Also, the green (G) channel of the data is sent from the DMA 920 to VIG 931, and the RGB channels and the fovea data are sent from the DMA 920 to the VIG 932. The VIG 930, VIG 931, and VIG 932 then send the data to the layer mixer 940. Next, the data is sent to the DSPP 950 and finally the display 960.

As shown in FIG. 9, the fovea data may utilize a single VIG (e.g., VIG 932) for scaling. Also, the periphery data may use the R/B channels in VIG 930 for parabolic correction, as well as the G channel in VIG 931 for parabolic correction as R/B. There may be a number of implications of this process. For instance, the G channel may not have a parabolic correction in a VIG. Further, the G channel may be rerouted as R/B in other VIGs. The R/B channels may be adjusted by chromatic aberration correction (CAC). The scaling ratio at the boundary of the transition may have a discontinuity. As such, aspects presented herein may utilize soft blending between the fovea region and the periphery region.

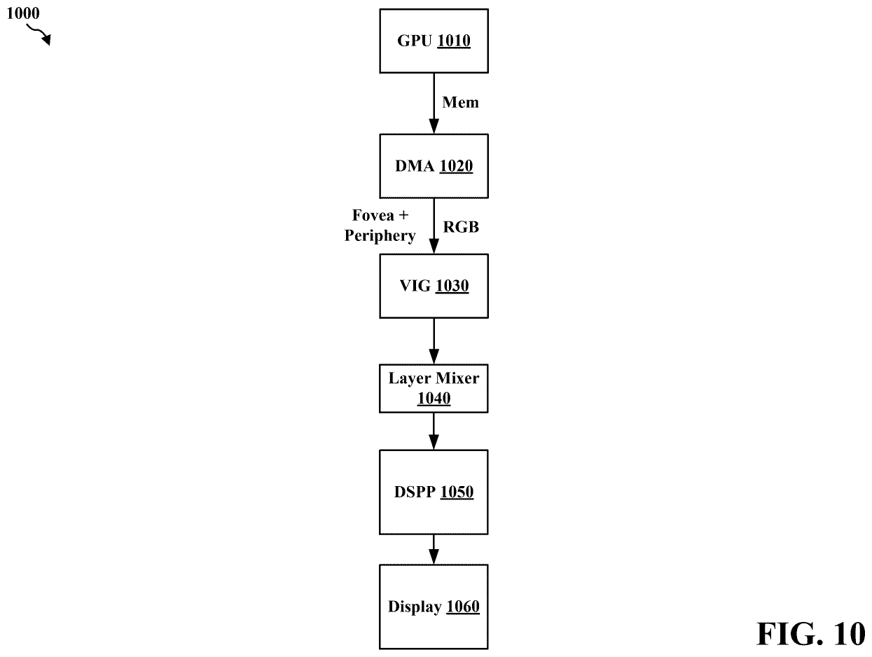

FIG. 10 is a diagram 1000 illustrating an example non-linear scaling process for graphics processing. More specifically, diagram 1000 depicts a non-linear scaling process that processes a single layer at a DPU. As shown in FIG. 10, diagram 1000 includes GPU 1010, direct memory access (DMA) processor (e.g., DMA 1020), video graphics (VIG) processor (e.g., VIG 1030), layer mixer 1040, destination surface processor (DSPP) (e.g., DSPP 1050) and display 1060. FIG. 10 depicts that memory data is sent from GPU 1010 to DMA 1020. After this, the RGB channels are sent from DMA 1020 to VIG 1030. Also, both the fovea data and the periphery data is sent from the DMA 1020 to the VIG 1030. The VIG 1030 then sends the data to the layer mixer 1040. Next, the data is sent to the DSPP 1050 and finally the display 1060.

As shown in FIG. 10, aspects presented herein may utilize a non-linear scaling process that processes a single layer at a DPU. For instance, the fovea data may utilize the central portion of a single VIG (e.g., VIG 1030) for scaling or bypass. Also, the periphery data may use a single VIG (e.g., VIG 1030) for scaling. There may be a number of implications of processes a single layer at a DPU. For instance, a parabolic scaling may be redefined. Also, a grid (e.g., an XY grid) may not be a certain shape (e.g., rectangular) or variable. Further, a central part of the image may have an arbitrary placement.

Additionally, referring back to FIG. 7, aspects presented herein may utilize a pipeline flow including a certain foveated scale applied to an image with lens distortion, foveated scaling, and foveated decoding. By doing so, aspects presented herein may improve the quality of images that undergo non-linear foveated compression. As shown in FIG. 7, aspects presented herein may utilize a process that inputs images with an original eye texture, and then process images that undergo foveated scaling and LDC, and then process images that undergo a foveated decoding process, and finally process images viewed through the lens. Further, results with foveated compression may maintain the same quality compared to results without foveated compression.

Aspects presented herein may include a number of benefits and advantages. For instance, aspects of the present disclosure may add to an existing GPU composition as part of distortion mapping. Aspects presented herein may also substantially reduce the rendering workload and system bandwidth, such as by providing a footprint compressed output buffer that retains a full resolution in the fovea region of an image and use just the memory necessary to represent the under-sampled periphery of the image. Further, system on-chip (SoC)-to-panel data rates may be reduced if the decoding is performed at the panel instead of at the DPU. Also, there may be a smooth transition from the fovea to the periphery of the image without the need to over-render or over-blend. Aspects presented herein may also utilize a single layer solution that avoids the complexity of handling multiple layers at the DPU.

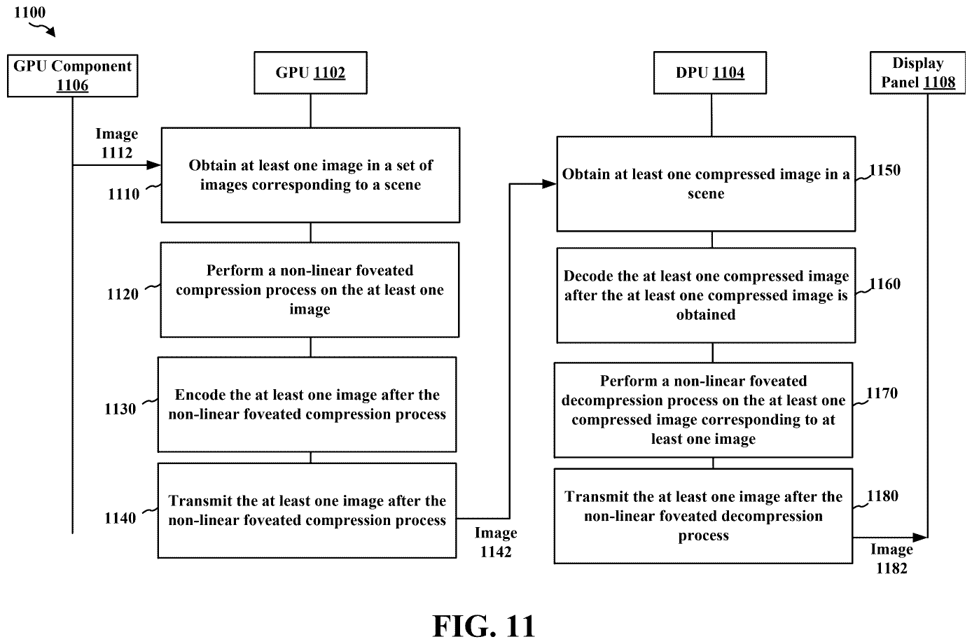

FIG. 11 is a communication flow diagram 1100 of graphics processing in accordance with one or more techniques of this disclosure. As shown in FIG. 11, diagram 1100 includes example communications between GPU 1102 (e.g., a component in a GPU or GPU pipeline), DPU 1104 (e.g., a component in a DPU or a display driver integrated circuit (DDIC)), GPU component 1106 (e.g., a component in a GPU or GPU pipeline, or other graphics processor), and display panel 1108, in accordance with one or more techniques of this disclosure.

At 1110, GPU 1102 may obtain at least one image (e.g., image 1112) in a set of images corresponding to a scene associated with the graphics processing. In some aspects, obtaining the at least one image may include: receiving the at least one image from at least one of a camera, at least one component in a graphics processing unit (GPU), or a video component. That is, the GPU may receive the at least one image from at least one of a camera, at least one component in a graphics processing unit (GPU), or a video component.

At 1120, GPU 1102 may perform a non-linear foveated compression process on the at least one image, where the non-linear foveated compression process corresponds to a continuous non-linear compression for a portion of the at least one image. The portion of the at least one image may be within a threshold distance from one or more edges of the at least one image. In some instances, performing the non-linear foveated compression process on the at least one image may include: filtering data associated with the at least one image, where the filtered data is associated with a reduced amount of aliasing compared to non-filtered data associated with the at least one image. That is, the GPU may filter data associated with the at least one image, where the filtered data is associated with a reduced amount of aliasing compared to non-filtered data associated with the at least one image. Also, performing the non-linear foveated compression process on the at least one image may include: performing a non-linear foveated scaling process on the at least one image. That is, the GPU may perform a non-linear foveated scaling process on the at least one image. The non-linear foveated compression process may be performed during a time warp process or a composition process.

In some aspects, the non-linear foveated compression process may correspond to at least one of: (i) a first continuous non-linear compression for one or more first portions of the at least one image, or (ii) a second continuous linear compression for one or more second portions of the at least one image. Also, the non-linear foveated compression process may correspond to at least one of: (i) a first continuous non-linear compression for a first portion of the at least one image, (ii) a second continuous linear compression for a second portion of the at least one image, or (iii) a third continuous non-linear compression for a third portion of the at least one image. The non-linear foveated compression process may also correspond to at least one of: (i) a first continuous linear compression for a first portion of the at least one image, (ii) a second continuous non-linear compression for a second portion of the at least one image, or (iii) a third continuous linear compression for a third portion of the at least one image. Further, the non-linear foveated compression process may correspond to the continuous non-linear compression for an entirety of the at least one image, such that the portion of the at least one image is equal to the entirety of the at least one image. The non-linear foveated compression process may be associated with a lens distortion correction (LDC) process or an anamorphic scaling process. The LDC process may be associated with at least one lens, where the at least one lens may be associated with an uneven image quality or an uneven pixel quality. Further, the non-linear foveated compression process may reduce an amount of data for the at least one image, where the data may be stored in at least one of a memory, a buffer, or an eye buffer.

At 1130, GPU 1102 may encode the at least one image after the non-linear foveated compression process is performed and before the at least one image is transmitted.

At 1140, GPU 1102 may transmit the at least one image (e.g., image 1142) after the non-linear foveated compression process, such that the transmitted at least one image corresponds to at least one compressed image. The at least one image may be transmitted to a display processing unit (DPU) or a display driver integrated circuit (DDIC).

At 1150, DPU 1104 may obtain at least one compressed image (e.g., image 1142) in a scene associated with the graphics processing, where the at least one compressed image is associated with a non-linear foveated compression process. In some aspects, obtaining the at least one compressed image may include: receiving the at least one compressed image from a graphics processing unit (GPU). That is, the DPU may receive the at least one compressed image from a GPU.

At 1160, DPU 1104 may decode the at least one compressed image after the at least one compressed image is obtained and before a non-linear foveated decompression process is performed.

At 1170, DPU 1104 may perform a non-linear foveated decompression process on the at least one compressed image, such that the at least one compressed image corresponds to at least one image, where the non-linear foveated decompression process corresponds to a continuous non-linear decompression for a portion of the at least one image. The portion of the at least one image may be within a threshold distance from one or more edges of the at least one image. In some instances, performing the non-linear foveated decompression process on the at least one image may include: performing a non-linear foveated scaling process on the at least one image. That is, the DPU may performing a non-linear foveated scaling process on the at least one image.

In some aspects, the non-linear foveated decompression process may correspond to at least one of: (i) a first continuous non-linear decompression for one or more first portions of the at least one image, or (ii) a second continuous linear decompression for one or more second portions of the at least one image. The non-linear foveated decompression process may also correspond to at least one of: (i) a first continuous non-linear decompression for a first portion of the at least one image, (ii) a second continuous linear decompression for a second portion of the at least one image, or (iii) a third continuous non-linear decompression for a third portion of the at least one image. Also, the non-linear foveated decompression process may correspond to at least one of: (i) a first continuous linear decompression for a first portion of the at least one image, (ii) a second continuous non-linear decompression for a second portion of the at least one image, or (iii) a third continuous linear decompression for a third portion of the at least one image. The non-linear foveated decompression process may be performed during a time warp process or a composition process. The non-linear foveated decompression process may correspond to the continuous non-linear decompression for an entirety of the at least one image, such that the portion of the at least one image may be equal to the entirety of the at least one image. Also, the non-linear foveated decompression process may be associated with a lens distortion correction (LDC) process or an anamorphic scaling process. The LDC process may be associated with at least one lens, where the at least one lens may be associated with an uneven image quality or an uneven pixel quality.

At 1180, DPU 1104 may transmit the at least one image (e.g., image 1182) after the non-linear foveated decompression process. In some instances, the at least one image may be transmitted to a display panel or a memory.

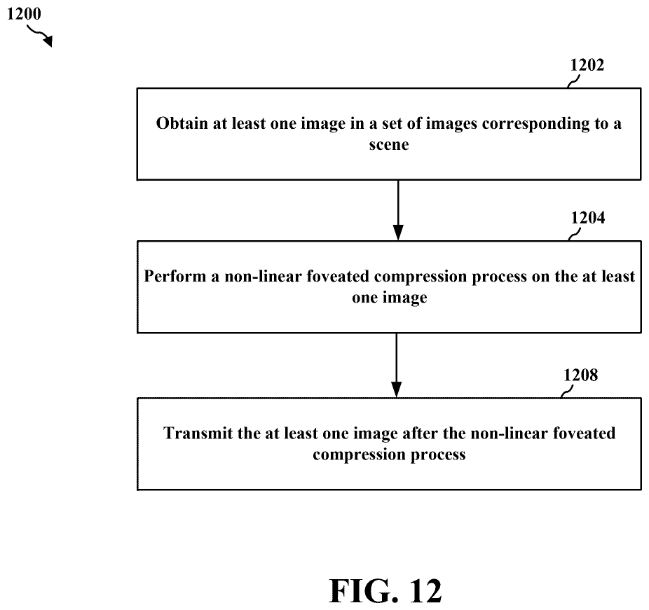

FIG. 12 is a flowchart 1200 of an example method of graphics processing in accordance with one or more techniques of this disclosure. The method may be performed by a GPU, a GPU component (e.g., a component in a GPU or GPU pipeline), a graphics processor, a CPU (or other central processor), a DPU (or other display processor, an apparatus for graphics processing, a wireless communication device, and/or any apparatus that may perform graphics processing as used in connection with the examples of FIGS. 1-11.

At 1202, the GPU may obtain at least one image in a set of images corresponding to a scene associated with the graphics processing, as described in connection with the examples in FIGS. 1-11. For example, as described in 1110 of FIG. 11, GPU 1102 may obtain at least one image in a set of images corresponding to a scene associated with the graphics processing. Further, step 1202 may be performed by processing unit 120 in FIG. 1. In some aspects, obtaining the at least one image may include: receiving the at least one image from at least one of a camera, at least one component in a graphics processing unit (GPU), or a video component. That is, the GPU may receive the at least one image from at least one of a camera, at least one component in a graphics processing unit (GPU), or a video component.

At 1204, the GPU may perform a non-linear foveated compression process on the at least one image, where the non-linear foveated compression process corresponds to a continuous non-linear compression for a portion of the at least one image, as described in connection with the examples in FIGS. 1-11. For example, as described in 1120 of FIG. 11, GPU 1102 may perform a non-linear foveated compression process on the at least one image, where the non-linear foveated compression process corresponds to a continuous non-linear compression for a portion of the at least one image. Further, step 1204 may be performed by processing unit 120 in FIG. 1. The portion of the at least one image may be within a threshold distance from one or more edges of the at least one image. In some instances, performing the non-linear foveated compression process on the at least one image may include: filtering data associated with the at least one image, where the filtered data is associated with a reduced amount of aliasing compared to non-filtered data associated with the at least one image. That is, the GPU may filter data associated with the at least one image, where the filtered data is associated with a reduced amount of aliasing compared to non-filtered data associated with the at least one image. Also, performing the non-linear foveated compression process on the at least one image may include: performing a non-linear foveated scaling process on the at least one image. That is, the GPU may perform a non-linear foveated scaling process on the at least one image. The non-linear foveated compression process may be performed during a time warp process or a composition process.

In some aspects, the non-linear foveated compression process may correspond to at least one of: (i) a first continuous non-linear compression for one or more first portions of the at least one image, or (ii) a second continuous linear compression for one or more second portions of the at least one image. Also, the non-linear foveated compression process may correspond to at least one of: (i) a first continuous non-linear compression for a first portion of the at least one image, (ii) a second continuous linear compression for a second portion of the at least one image, or (iii) a third continuous non-linear compression for a third portion of the at least one image. The non-linear foveated compression process may also correspond to at least one of: (i) a first continuous linear compression for a first portion of the at least one image, (ii) a second continuous non-linear compression for a second portion of the at least one image, or (iii) a third continuous linear compression for a third portion of the at least one image. Further, the non-linear foveated compression process may correspond to the continuous non-linear compression for an entirety of the at least one image, such that the portion of the at least one image is equal to the entirety of the at least one image. The non-linear foveated compression process may be associated with a lens distortion correction (LDC) process or an anamorphic scaling process. The LDC process may be associated with at least one lens, where the at least one lens may be associated with an uneven image quality or an uneven pixel quality. Further, the non-linear foveated compression process may reduce an amount of data for the at least one image, where the data may be stored in at least one of a memory, a buffer, or an eye buffer.

At 1208, the GPU may transmit the at least one image after the non-linear foveated compression process, such that the transmitted at least one image corresponds to at least one compressed image, as described in connection with the examples in FIGS. 1-11. For example, as described in 1140 of FIG. 11, GPU 1102 may transmit the at least one image after the non-linear foveated compression process, such that the transmitted at least one image corresponds to at least one compressed image. Further, step 1208 may be performed by processing unit 120 in FIG. 1. The at least one image may be transmitted to a display processing unit (DPU) or a display driver integrated circuit (DDIC).

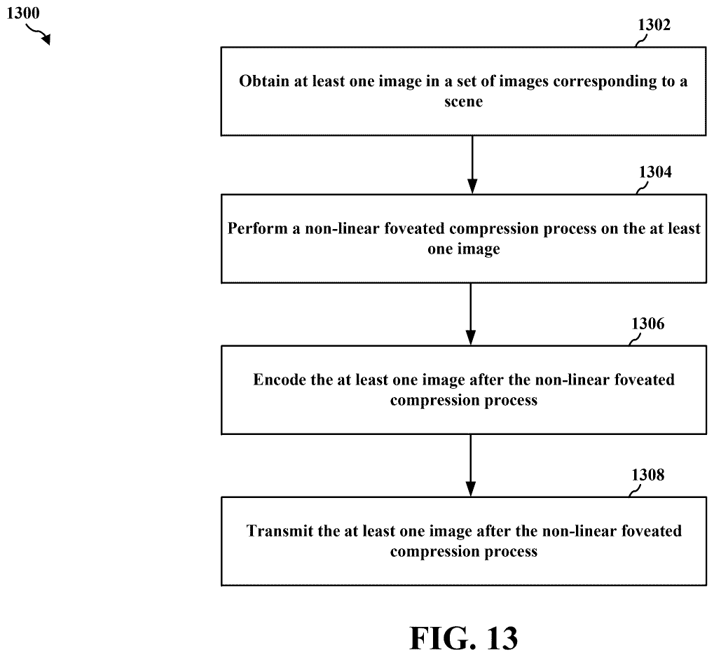

FIG. 13 is a flowchart 1300 of an example method of graphics processing in accordance with one or more techniques of this disclosure. The method may be performed by a GPU, a GPU component (e.g., a component in a GPU or GPU pipeline), a graphics processor, a CPU (or other central processor), a DPU (or other display processor, an apparatus for graphics processing, a wireless communication device, and/or any apparatus that may perform graphics processing as used in connection with the examples of FIGS. 1-11.

At 1302, the GPU may obtain at least one image in a set of images corresponding to a scene associated with the graphics processing, as described in connection with the examples in FIGS. 1-11. For example, as described in 1110 of FIG. 11, GPU 1102 may obtain at least one image in a set of images corresponding to a scene associated with the graphics processing. Further, step 1302 may be performed by processing unit 120 in FIG. 1. In some aspects, obtaining the at least one image may include: receiving the at least one image from at least one of a camera, at least one component in a graphics processing unit (GPU), or a video component. That is, the GPU may receive the at least one image from at least one of a camera, at least one component in a graphics processing unit (GPU), or a video component.

At 1304, the GPU may perform a non-linear foveated compression process on the at least one image, where the non-linear foveated compression process corresponds to a continuous non-linear compression for a portion of the at least one image, as described in connection with the examples in FIGS. 1-11. For example, as described in 1120 of FIG. 11, GPU 1102 may perform a non-linear foveated compression process on the at least one image, where the non-linear foveated compression process corresponds to a continuous non-linear compression for a portion of the at least one image. Further, step 1304 may be performed by processing unit 120 in FIG. 1. The portion of the at least one image may be within a threshold distance from one or more edges of the at least one image. In some instances, performing the non-linear foveated compression process on the at least one image may include: filtering data associated with the at least one image, where the filtered data is associated with a reduced amount of aliasing compared to non-filtered data associated with the at least one image. That is, the GPU may filter data associated with the at least one image, where the filtered data is associated with a reduced amount of aliasing compared to non-filtered data associated with the at least one image. Also, performing the non-linear foveated compression process on the at least one image may include: performing a non-linear foveated scaling process on the at least one image. That is, the GPU may perform a non-linear foveated scaling process on the at least one image. The non-linear foveated compression process may be performed during a time warp process or a composition process. Also, the non-linear foveated compression process may be associated with an anisotropic filtering process or a trilinear filtering process with one or more mipmaps, where the anisotropic filtering process or the trilinear filtering process may be associated with a reduced amount of under-sampling or flickering artifacts. By doing so, when the DPU or DDIC reverse the compression, there may not be any under-sampling introduced artifacts.

In some aspects, the non-linear foveated compression process may correspond to at least one of: (i) a first continuous non-linear compression for one or more first portions of the at least one image, or (ii) a second continuous linear compression for one or more second portions of the at least one image. Also, the non-linear foveated compression process may correspond to at least one of: (i) a first continuous non-linear compression for a first portion of the at least one image, (ii) a second continuous linear compression for a second portion of the at least one image, or (iii) a third continuous non-linear compression for a third portion of the at least one image. The non-linear foveated compression process may also correspond to at least one of: (i) a first continuous linear compression for a first portion of the at least one image, (ii) a second continuous non-linear compression for a second portion of the at least one image, or (iii) a third continuous linear compression for a third portion of the at least one image. Further, the non-linear foveated compression process may correspond to the continuous non-linear compression for an entirety of the at least one image, such that the portion of the at least one image is equal to the entirety of the at least one image. The non-linear foveated compression process may be associated with a lens distortion correction (LDC) process or an anamorphic scaling process. The LDC process may be associated with at least one lens, where the at least one lens may be associated with an uneven image quality or an uneven pixel quality. Further, the non-linear foveated compression process may reduce an amount of data for the at least one image, where the data may be stored in at least one of a memory, a buffer, or an eye buffer.

At 1306, the GPU may encode the at least one image after the non-linear foveated compression process is performed and before the at least one image is transmitted, as described in connection with the examples in FIGS. 1-11. For example, as described in 1130 of FIG. 11, GPU 1102 may encode the at least one image after the non-linear foveated compression process is performed and before the at least one image is transmitted. Further, step 1306 may be performed by processing unit 120 in FIG. 1.

At 1308, the GPU may transmit the at least one image after the non-linear foveated compression process, such that the transmitted at least one image corresponds to at least one compressed image, as described in connection with the examples in FIGS. 1-11. For example, as described in 1140 of FIG. 11, GPU 1102 may transmit the at least one image after the non-linear foveated compression process, such that the transmitted at least one image corresponds to at least one compressed image. Further, step 1308 may be performed by processing unit 120 in FIG. 1. The at least one image may be transmitted to a display processing unit (DPU) or a display driver integrated circuit (DDIC).

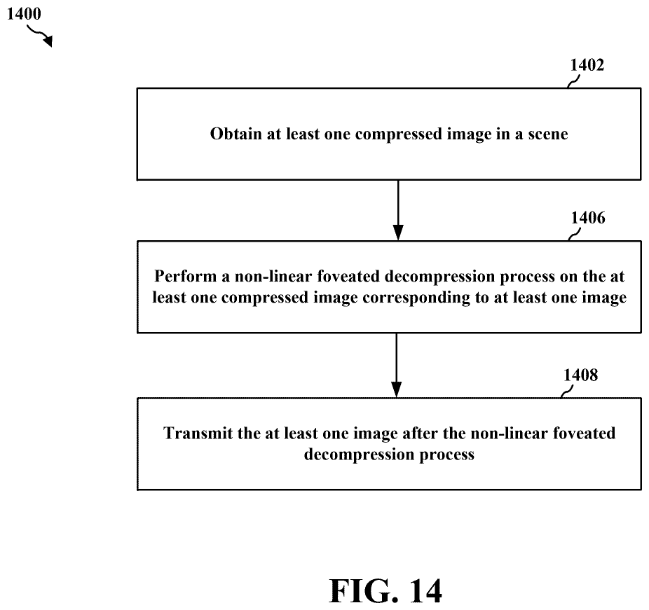

FIG. 14 is a flowchart 1400 of an example method of graphics processing in accordance with one or more techniques of this disclosure. The method may be performed by a DPU (or other display processor), a DDIC, a GPU, a GPU component (e.g., a component in a GPU or GPU pipeline), a graphics processor, a CPU (or other central processor), an apparatus for graphics processing, a wireless communication device, and/or any apparatus that may perform graphics processing as used in connection with the examples of FIGS. 1-11.

At 1402, the DPU may obtain at least one compressed image in a scene associated with the graphics processing, where the at least one compressed image is associated with a non-linear foveated compression process, as described in connection with the examples in FIGS. 1-11. For example, as described in 1150 of FIG. 11, DPU 1104 may obtain at least one compressed image in a scene associated with the graphics processing, where the at least one compressed image is associated with a non-linear foveated compression process. Further, step 1402 may be performed by display processor 127 in FIG. 1. In some aspects, obtaining the at least one compressed image may include: receiving the at least one compressed image from a graphics processing unit (GPU). That is, the DPU may receive the at least one compressed image from a GPU.

At 1406, the DPU may perform a non-linear foveated decompression process on the at least one compressed image, such that the at least one compressed image corresponds to at least one image, where the non-linear foveated decompression process corresponds to a continuous non-linear decompression for a portion of the at least one image, as described in connection with the examples in FIGS. 1-11. For example, as described in 1170 of FIG. 11, DPU 1104 may perform a non-linear foveated decompression process on the at least one compressed image, such that the at least one compressed image corresponds to at least one image, where the non-linear foveated decompression process corresponds to a continuous non-linear decompression for a portion of the at least one image. Further, step 1406 may be performed by display processor 127 in FIG. 1. The portion of the at least one image may be within a threshold distance from one or more edges of the at least one image. In some instances, performing the non-linear foveated decompression process on the at least one image may include: performing a non-linear foveated scaling process on the at least one image. That is, the DPU may performing a non-linear foveated scaling process on the at least one image.

In some aspects, the non-linear foveated decompression process may correspond to at least one of: (i) a first continuous non-linear decompression for one or more first portions of the at least one image, or (ii) a second continuous linear decompression for one or more second portions of the at least one image. The non-linear foveated decompression process may also correspond to at least one of: (i) a first continuous non-linear decompression for a first portion of the at least one image, (ii) a second continuous linear decompression for a second portion of the at least one image, or (iii) a third continuous non-linear decompression for a third portion of the at least one image. Also, the non-linear foveated decompression process may correspond to at least one of: (i) a first continuous linear decompression for a first portion of the at least one image, (ii) a second continuous non-linear decompression for a second portion of the at least one image, or (iii) a third continuous linear decompression for a third portion of the at least one image. The non-linear foveated decompression process may be performed during a time warp process or a composition process. Also, the non-linear foveated compression process may be associated with an anisotropic filtering process or a trilinear filtering process with one or more mipmaps, where the anisotropic filtering process or the trilinear filtering process may be associated with a reduced amount of under-sampling or flickering artifacts. By doing so, when the DPU or DDIC reverse the compression, there may not be any under-sampling introduced artifacts. The non-linear foveated decompression process may correspond to the continuous non-linear decompression for an entirety of the at least one image, such that the portion of the at least one image may be equal to the entirety of the at least one image. Also, the non-linear foveated decompression process may be associated with a lens distortion correction (LDC) process or an anamorphic scaling process. The LDC process may be associated with at least one lens, where the at least one lens may be associated with an uneven image quality or an uneven pixel quality.

At 1408, the DPU may transmit the at least one image after the non-linear foveated decompression process, as described in connection with the examples in FIGS. 1-11. For example, as described in 1180 of FIG. 11, DPU 1104 may transmit the at least one image after the non-linear foveated decompression process. Further, step 1408 may be performed by display processor 127 in FIG. 1. In some instances, the at least one image may be transmitted to a display panel or a memory.

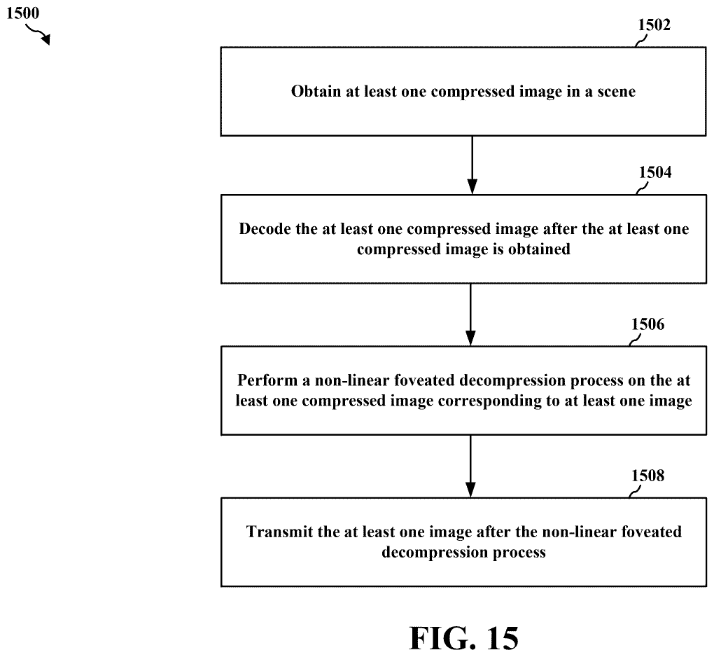

FIG. 15 is a flowchart 1500 of an example method of graphics processing in accordance with one or more techniques of this disclosure. The method may be performed by a DPU (or other display processor), a DDIC, a GPU, a GPU component (e.g., a component in a GPU or GPU pipeline), a graphics processor, a CPU (or other central processor), an apparatus for graphics processing, a wireless communication device, and/or any apparatus that may perform graphics processing as used in connection with the examples of FIGS. 1-11.

At 1502, the DPU may obtain at least one compressed image in a scene associated with the graphics processing, where the at least one compressed image is associated with a non-linear foveated compression process, as described in connection with the examples in FIGS. 1-11. For example, as described in 1150 of FIG. 11, DPU 1104 may obtain at least one compressed image in a scene associated with the graphics processing, where the at least one compressed image is associated with a non-linear foveated compression process. Further, step 1502 may be performed by display processor 127 in FIG. 1. In some aspects, obtaining the at least one compressed image may include: receiving the at least one compressed image from a graphics processing unit (GPU). That is, the DPU may receive the at least one compressed image from a GPU.

At 1504, the DPU may decode the at least one compressed image after the at least one compressed image is obtained and before a non-linear foveated decompression process is performed, as described in connection with the examples in FIGS. 1-11. For example, as described in 1160 of FIG. 11, DPU 1104 may decode the at least one compressed image after the at least one compressed image is obtained and before a non-linear foveated decompression process is performed. Further, step 1504 may be performed by display processor 127 in FIG. 1.

At 1506, the DPU may perform a non-linear foveated decompression process on the at least one compressed image, such that the at least one compressed image corresponds to at least one image, where the non-linear foveated decompression process corresponds to a continuous non-linear decompression for a portion of the at least one image, as described in connection with the examples in FIGS. 1-11. For example, as described in 1170 of FIG. 11, DPU 1104 may perform a non-linear foveated decompression process on the at least one compressed image, such that the at least one compressed image corresponds to at least one image, where the non-linear foveated decompression process corresponds to a continuous non-linear decompression for a portion of the at least one image. Further, step 1506 may be performed by display processor 127 in FIG. 1. The portion of the at least one image may be within a threshold distance from one or more edges of the at least one image. In some instances, performing the non-linear foveated decompression process on the at least one image may include: performing a non-linear foveated scaling process on the at least one image. That is, the DPU may performing a non-linear foveated scaling process on the at least one image.

In some aspects, the non-linear foveated decompression process may correspond to at least one of: (i) a first continuous non-linear decompression for one or more first portions of the at least one image, or (ii) a second continuous linear decompression for one or more second portions of the at least one image. The non-linear foveated decompression process may also correspond to at least one of: (i) a first continuous non-linear decompression for a first portion of the at least one image, (ii) a second continuous linear decompression for a second portion of the at least one image, or (iii) a third continuous non-linear decompression for a third portion of the at least one image. Also, the non-linear foveated decompression process may correspond to at least one of: (i) a first continuous linear decompression for a first portion of the at least one image, (ii) a second continuous non-linear decompression for a second portion of the at least one image, or (iii) a third continuous linear decompression for a third portion of the at least one image. The non-linear foveated decompression process may be performed during a time warp process or a composition process. Also, the non-linear foveated compression process may be associated with an anisotropic filtering process or a trilinear filtering process with one or more mipmaps, where the anisotropic filtering process or the trilinear filtering process may be associated with a reduced amount of under-sampling or flickering artifacts. By doing so, when the DPU or DDIC reverse the compression, there may not be any under-sampling introduced artifacts. The non-linear foveated decompression process may correspond to the continuous non-linear decompression for an entirety of the at least one image, such that the portion of the at least one image may be equal to the entirety of the at least one image. Also, the non-linear foveated decompression process may be associated with a lens distortion correction (LDC) process or an anamorphic scaling process. The LDC process may be associated with at least one lens, where the at least one lens may be associated with an uneven image quality or an uneven pixel quality.

At 1508, the DPU may transmit the at least one image after the non-linear foveated decompression process, as described in connection with the examples in FIGS. 1-11. For example, as described in 1180 of FIG. 11, DPU 1104 may transmit the at least one image after the non-linear foveated decompression process. Further, step 1508 may be performed by display processor 127 in FIG. 1. In some instances, the at least one image may be transmitted to a display panel or a memory.

In configurations, a method or an apparatus for graphics processing is provided. The apparatus may be a GPU, a GPU component (e.g., a component in a GPU or GPU pipeline, software for controlling a GPU, or a processor for controlling a GPU), a graphics processor, a CPU (or other central processor), a DPU (or other display processor), an apparatus for graphics processing, a wireless communication device, and/or some other processor that may perform graphics processing. In aspects, the apparatus may be the processing unit 120 within the device 104, or may be some other hardware within the device 104 or another device. The apparatus, e.g., processing unit 120, may include means for obtaining at least one image in a set of images corresponding to a scene associated with the graphics processing. The apparatus, e.g., processing unit 120, may also include means for performing a non-linear foveated compression process on the at least one image, where the non-linear foveated compression process corresponds to a continuous non-linear compression for a portion of the at least one image. The apparatus, e.g., processing unit 120, may also include means for transmitting the at least one image after the non-linear foveated compression process, such that the transmitted at least one image corresponds to at least one compressed image. The apparatus, e.g., processing unit 120, may also include means for encoding the at least one image after the non-linear foveated compression process is performed and before the at least one image is transmitted. In aspects, the apparatus may be the display processor 127 within the device 104, or may be some other hardware within the device 104 or another device. The apparatus, e.g., display processor 127, may include means for obtaining at least one compressed image in a scene associated with the graphics processing, where the at least one compressed image is associated with a non-linear foveated compression process. The apparatus, e.g., display processor 127, may also include means for performing a non-linear foveated decompression process on the at least one compressed image, such that the at least one compressed image corresponds to at least one image, where the non-linear foveated decompression process corresponds to a continuous non-linear decompression for a portion of the at least one image. The apparatus, e.g., display processor 127, may also include means for transmitting the at least one image after the non-linear foveated decompression process. The apparatus, e.g., display processor 127, may also include means for decoding the at least one compressed image after the at least one compressed image is obtained and before the non-linear foveated decompression process is performed.

The subject matter described herein may be implemented to realize one or more benefits or advantages. For instance, the described graphics processing techniques may be used by a GPU, a GPU component, a CPU, a DPU, a display processor, a graphics processor, an apparatus for graphics processing, or some other processor that may perform graphics processing to implement the foveated scaling techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize foveated scaling techniques in order to improve memory bandwidth efficiency and/or increase processing speed at a GPU, a DPU, or a CPU.

It is understood that the specific order or hierarchy of blocks in the processes/flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing (e.g., an apparatus at a GPU), including a memory and at least one processor coupled to the memory and, based at least in part on information stored in the memory, the at least one processor is configured to: obtain at least one image in a set of images corresponding to a scene associated with the graphics processing; perform a non-linear foveated compression process on the at least one image, where the non-linear foveated compression process corresponds to a continuous non-linear compression for a portion of the at least one image; and transmit the at least one image after the non-linear foveated compression process, such that the transmitted at least one image corresponds to at least one compressed image.

Aspect 2 is the apparatus of aspect 1, where the portion of the at least one image is within a threshold distance from one or more edges of the at least one image.

Aspect 3 is the apparatus of any of aspects 1 and 2, where the non-linear foveated compression process corresponds to at least one of: (i) a first continuous non-linear compression for one or more first portions of the at least one image, or (ii) a second continuous linear compression for one or more second portions of the at least one image.

Aspect 4 is the apparatus of any of aspects 1 to 3, where the non-linear foveated compression process corresponds to at least one of: (i) a first continuous non-linear compression for a first portion of the at least one image, (ii) a second continuous linear compression for a second portion of the at least one image, or (iii) a third continuous non-linear compression for a third portion of the at least one image.

Aspect 5 is the apparatus of any of aspects 1 to 4, where the non-linear foveated compression process corresponds to at least one of: (i) a first continuous linear compression for a first portion of the at least one image, (ii) a second continuous non-linear compression for a second portion of the at least one image, or (iii) a third continuous linear compression for a third portion of the at least one image.

Aspect 6 is the apparatus of any of aspects 1 to 5, where the at least one processor is further configured to: encode the at least one image after the non-linear foveated compression process is performed and before the at least one image is transmitted.

Aspect 7 is the apparatus of any of aspects 1 to 6, where to perform the non-linear foveated compression process on the at least one image, the at least one processor is configured to: filter data associated with the at least one image, where the filtered data is associated with a reduced amount of aliasing compared to non-filtered data associated with the at least one image.

Aspect 8 is the apparatus of any of aspects 1 to 7, where the non-linear foveated compression process is performed during a time warp process or a composition process, where the non-linear foveated compression process is associated with an anisotropic filtering process or a trilinear filtering process with one or more mipmaps, wherein the anisotropic filtering process or the trilinear filtering process is associated with a reduced amount of under-sampling or flickering artifacts.

Aspect 9 is the apparatus of any of aspects 1 to 8, where the non-linear foveated compression process corresponds to the continuous non-linear compression for an entirety of the at least one image, such that the portion of the at least one image is equal to the entirety of the at least one image.

Aspect 10 is the apparatus of any of aspects 1 to 9, where to perform the non-linear foveated compression process on the at least one image, the at least one processor is configured to: perform a non-linear foveated scaling process on the at least one image.

Aspect 11 is the apparatus of any of aspects 1 to 10, where the non-linear foveated compression process is associated with a lens distortion correction (LDC) process or an anamorphic scaling process.

Aspect 12 is the apparatus of any of aspects 1 to 11, where the LDC process is associated with at least one lens, where the at least one lens is associated with an uneven image quality or an uneven pixel quality.

Aspect 13 is the apparatus of any of aspects 1 to 12, where the non-linear foveated compression process reduces an amount of data for the at least one image, where the data is to be stored in at least one of a memory, a buffer, or an eye buffer.

Aspect 14 is the apparatus of any of aspects 1 to 13, where to obtain the at least one image, the at least one processor is configured to: receive the at least one image from at least one of a camera, at least one component in a graphics processing unit (GPU), or a video component.

Aspect 15 is the apparatus of any of aspects 1 to 14, where the at least one image is transmitted to a display processing unit (DPU) or a display driver integrated circuit (DDIC).

Aspect 16 is an apparatus for graphics processing (e.g., an apparatus at a DPU), including a memory and at least one processor coupled to the memory and, based at least in part on information stored in the memory, the at least one processor is configured to: obtain at least one compressed image in a scene associated with the graphics processing, where the at least one compressed image is associated with a non-linear foveated compression process; perform a non-linear foveated decompression process on the at least one compressed image, such that the at least one compressed image corresponds to at least one image, where the non-linear foveated decompression process corresponds to a continuous non-linear decompression for a portion of the at least one image; and transmitting the at least one image after the non-linear foveated decompression process.

Aspect 17 is the apparatus of aspect 16, where the portion of the at least one image is within a threshold distance from one or more edges of the at least one image.

Aspect 18 is the apparatus of any of aspects 16 and 17, where the non-linear foveated decompression process corresponds to at least one of: (i) a first continuous non-linear decompression for one or more first portions of the at least one image, or (ii) a second continuous linear decompression for one or more second portions of the at least one image.

Aspect 19 is the apparatus of any of aspects 16 to 18, where the non-linear foveated decompression process corresponds to at least one of: (i) a first continuous non-linear decompression for a first portion of the at least one image, (ii) a second continuous linear decompression for a second portion of the at least one image, or (iii) a third continuous non-linear decompression for a third portion of the at least one image.

Aspect 20 is the apparatus of any of aspects 16 to 19, where the non-linear foveated decompression process corresponds to at least one of: (i) a first continuous linear decompression for a first portion of the at least one image, (ii) a second continuous non-linear decompression for a second portion of the at least one image, or (iii) a third continuous linear decompression for a third portion of the at least one image.

Aspect 21 is the apparatus of any of aspects 16 to 20, where the at least one processor is further configured to: decode the at least one compressed image after the at least one compressed image is obtained and before the non-linear foveated decompression process is performed.

Aspect 22 is the apparatus of any of aspects 16 to 21, where the non-linear foveated decompression process is performed during a time warp process or a composition process, where the non-linear foveated compression process is associated with an anisotropic filtering process or a trilinear filtering process with one or more mipmaps, wherein the anisotropic filtering process or the trilinear filtering process is associated with a reduced amount of under-sampling or flickering artifacts.

Aspect 23 is the apparatus of any of aspects 16 to 22, where the non-linear foveated decompression process corresponds to the continuous non-linear decompression for an entirety of the at least one image, such that the portion of the at least one image is equal to the entirety of the at least one image.

Aspect 24 is the apparatus of any of aspects 16 to 23, where to perform the non-linear foveated decompression process on the at least one image, the at least one processor is configured to: perform a non-linear foveated scaling process on the at least one image.

Aspect 25 is the apparatus of any of aspects 16 to 24, where the non-linear foveated decompression process is associated with a lens distortion correction (LDC) process or an anamorphic scaling process.

Aspect 26 is the apparatus of any of aspects 16 to 25, where the LDC process is associated with at least one lens, where the at least one lens is associated with an uneven image quality or an uneven pixel quality.

Aspect 27 is the apparatus of any of aspects 16 to 26, where to obtain the at least one compressed image, the at least one processor is configured to: receive the at least one compressed image from a graphics processing unit (GPU).

Aspect 28 is the apparatus of any of aspects 16 to 27, where the at least one image is transmitted to a display panel or a memory.

Aspect 29 is the apparatus of any of aspects 1 to 28, where the apparatus is a wireless communication device, further including at least one of an antenna or a transceiver coupled to the at least one processor.

Aspect 30 is a method of graphics processing for implementing any of aspects 1 to 28.

Aspect 31 is an apparatus for graphics processing including means for implementing any of aspects 1 to 28.

Aspect 32 is a computer-readable medium (e.g., a non-transitory computer-readable medium) storing computer executable code, the code when executed by at least one processor causes the at least one processor to implement any of aspects 1 to 28.

What is claimed is:

1. An apparatus for graphics processing, comprising:
a memory; and
at least one processor coupled to the memory and, based at least in part on information stored in the memory, the at least one processor is configured to:
obtain at least one image in a set of images corresponding to a scene associated with the graphics processing;
perform a non-linear foveated compression process on the at least one image, wherein the non-linear foveated compression process corresponds to a continuous non-linear compression for a portion of the at least one image; and
transmit the at least one image after the non-linear foveated compression process, such that the transmitted at least one image corresponds to at least one compressed image.

2. The apparatus of claim 1, wherein the portion of the at least one image is within a threshold distance from one or more edges of the at least one image.

3. The apparatus of claim 1, wherein the non-linear foveated compression process corresponds to at least one of: (i) a first continuous non-linear compression for one or more first portions of the at least one image, or (ii) a second continuous linear compression for one or more second portions of the at least one image.

4. The apparatus of claim 1, wherein the non-linear foveated compression process corresponds to at least one of: (i) a first continuous non-linear compression for a first portion of the at least one image, (ii) a second continuous linear compression for a second portion of the at least one image, or (iii) a third continuous non-linear compression for a third portion of the at least one image.

5. The apparatus of claim 1, wherein the non-linear foveated compression process corresponds to at least one of: (i) a first continuous linear compression for a first portion of the at least one image, (ii) a second continuous non-linear compression for a second portion of the at least one image, or (iii) a third continuous linear compression for a third portion of the at least one image.

6. The apparatus of claim 1, wherein the at least one processor is further configured to:
encode the at least one image after the non-linear foveated compression process is performed and before the at least one image is transmitted.

7. The apparatus of claim 1, wherein to perform the non-linear foveated compression process on the at least one image, the at least one processor is configured to: filter data associated with the at least one image, wherein the filtered data is associated with a reduced amount of aliasing compared to non-filtered data associated with the at least one image.

8. The apparatus of claim 1, wherein the non-linear foveated compression process is performed during a time warp process or a composition process, wherein the non-linear foveated compression process is associated with an anisotropic filtering process or a trilinear filtering process with one or more mipmaps, wherein the anisotropic filtering process or the trilinear filtering process is associated with a reduced amount of under-sampling or flickering artifacts.

9. The apparatus of claim 1, wherein the non-linear foveated compression process corresponds to the continuous non-linear compression for an entirety of the at least one image, such that the portion of the at least one image is equal to the entirety of the at least one image.

10. The apparatus of claim 1, wherein to perform the non-linear foveated compression process on the at least one image, the at least one processor is configured to: perform a non-linear foveated scaling process on the at least one image.

11. The apparatus of claim 1, wherein the non-linear foveated compression process is associated with a lens distortion correction (LDC) process or an anamorphic scaling process.

12. The apparatus of claim 11, wherein the LDC process is associated with at least one lens, wherein the at least one lens is associated with an uneven image quality or an uneven pixel quality.

13. The apparatus of claim 1, wherein the non-linear foveated compression process reduces an amount of data for the at least one image, wherein the data is to be stored in at least one of a memory, a buffer, or an eye buffer.

14. The apparatus of claim 1, wherein to obtain the at least one image, the at least one processor is configured to: receive the at least one image from at least one of a camera, at least one component in a graphics processing unit (GPU), or a video component.

15. The apparatus of claim 1, further comprising at least one of an antenna or a transceiver coupled to the at least one processor, wherein the at least one image is transmitted to a display processing unit (DPU) or a display driver integrated circuit (DDIC).

16. An apparatus for graphics processing, comprising:
a memory; and
at least one processor coupled to the memory and, based at least in part on information stored in the memory, the at least one processor is configured to:
obtain at least one compressed image in a scene associated with the graphics processing, wherein the at least one compressed image is associated with a non-linear foveated compression process;
perform a non-linear foveated decompression process on the at least one compressed image, such that the at least one compressed image corresponds to at least one image, wherein the non-linear foveated decompression process corresponds to a continuous non-linear decompression for a portion of the at least one image; and
transmit the at least one image after the non-linear foveated decompression process.

17. The apparatus of claim 16, wherein the portion of the at least one image is within a threshold distance from one or more edges of the at least one image.

18. The apparatus of claim 16, wherein the non-linear foveated decompression process corresponds to at least one of: (i) a first continuous non-linear decompression for one or more first portions of the at least one image, or (ii) a second continuous linear decompression for one or more second portions of the at least one image.

19. The apparatus of claim 16, wherein the non-linear foveated decompression process corresponds to at least one of: (i) a first continuous non-linear decompression for a first portion of the at least one image, (ii) a second continuous linear decompression for a second portion of the at least one image, or (iii) a third continuous non-linear decompression for a third portion of the at least one image.

20. The apparatus of claim 16, wherein the non-linear foveated decompression process corresponds to at least one of: (i) a first continuous linear decompression for a first portion of the at least one image, (ii) a second continuous non-linear decompression for a second portion of the at least one image, or (iii) a third continuous linear decompression for a third portion of the at least one image.

21. The apparatus of claim 16, wherein the at least one processor is further configured to:
decode the at least one compressed image after the at least one compressed image is obtained and before the non-linear foveated decompression process is performed.

22. The apparatus of claim 16, wherein the non-linear foveated decompression process is performed during a time warp process or a composition process, wherein the non-linear foveated compression process is associated with an anisotropic filtering process or a trilinear filtering process with one or more mipmaps, wherein the anisotropic filtering process or the trilinear filtering process is associated with a reduced amount of under-sampling or flickering artifacts.

23. The apparatus of claim 16, wherein the non-linear foveated decompression process corresponds to the continuous non-linear decompression for an entirety of the at least one image, such that the portion of the at least one image is equal to the entirety of the at least one image.

24. The apparatus of claim 16, wherein to perform the non-linear foveated decompression process on the at least one image, the at least one processor is configured to: perform a non-linear foveated scaling process on the at least one image.

25. The apparatus of claim 16, wherein the non-linear foveated decompression process is associated with a lens distortion correction (LDC) process or an anamorphic scaling process.

26. The apparatus of claim 25, wherein the LDC process is associated with at least one lens, wherein the at least one lens is associated with an uneven image quality or an uneven pixel quality.

27. The apparatus of claim 16, wherein to obtain the at least one compressed image, the at least one processor is configured to: receive the at least one compressed image from a graphics processing unit (GPU).

28. The apparatus of claim 16, further comprising at least one of an antenna or a transceiver coupled to the at least one processor, wherein the at least one image is transmitted to a display panel or a memory.

29. A method of graphics processing, comprising:
obtaining at least one image in a set of images corresponding to a scene associated with the graphics processing;
performing a non-linear foveated compression process on the at least one image, wherein the non-linear foveated compression process corresponds to a continuous non-linear compression for a portion of the at least one image; and
transmitting the at least one image after the non-linear foveated compression process, such that the transmitted at least one image corresponds to at least one compressed image.

30. A method of graphics processing, comprising:
obtaining at least one compressed image in a scene associated with the graphics processing, wherein the at least one compressed image is associated with a non-linear foveated compression process;
performing a non-linear foveated decompression process on the at least one compressed image, such that the at least one compressed image corresponds to at least one image, wherein the non-linear foveated decompression process corresponds to a continuous non-linear decompression for a portion of the at least one image; and
transmitting the at least one image after the non-linear foveated decompression process.
